(19) United States
(12) Patent Application Publication
(10) Pub. No.: US 2011/0003494 A1
(43) Pub. Date: Jan. 6, 2011

(54) Electrical outlet safety device and method of use

(76) Inventor: Truc S. Tang, Santa Ana, CA (US)

Correspondence Address: CONNORS ASSOCIATES, 1600 DOVE ST, SUITE 220, NEWPORT BEACH, CA, 92660, US

(21) Appl. No.: 12/781,858

(22) Filed: May 18, 2010

Related U.S. Application Data
(60) Provisional application No. 61/222,750, filed on Jul. 2, 2009.

(51) Int. Cl. H01R 13/44; B23P 11/00

(52) U.S. Cl. 439/149; 29/428

(57) ABSTRACT

The danger associated with an electrical plug partially withdrawn from an electrical outlet to exposed prongs of the plug while in electrical connection is reduced using a safety device comprising a resilient, compressible block of electrical insulating material mounted to a connection side of the plug. The prongs are inserted into passageways in the block that extend from one side of the block to another side of the block. With the block mounted to the plug, the user pushes the prongs into the outlet so the prongs are essentially completely within the outlet and the block is essentially completely compressed. The compressed block expands to cover the exposed, electrically connected plug portions upon partial removal of the prongs from the electrical outlet.

### RELATED PATENT APPLICATIONS & INCORPORATION BY REFERENCE

This utility application claims the benefit under 35 USC 119(e) of U.S. Provisional Patent Application No. 61/222,750, entitled “ELECTRICAL OUTLET SAFETY DEVICE AND METHOD OF USE,” filed Jul. 2, 2009. This related application is incorporated herein by reference and made a part of this application. If any conflict arises between the disclosure of the invention in this utility application and that in the related provisional application, the disclosure in this utility application shall govern. Moreover, any and all U.S. patents, U.S. patent applications, and other documents, hard copy or electronic, cited or referred to in this application are incorporated herein by reference and made a part of this application.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The word “rectangular” includes square.

The words “substantially” and “essentially” have equivalent meanings.

### BACKGROUND

A hazard exists when the prongs of an electrical plug are inserted into an electrical outlet to achieve electrical contact but partially exposes the prongs. This condition is especially dangerous to young children who may touch the partially exposed prongs with their fingers or with an electrically conductive object.

### SUMMARY

The objective of my device and method of use is to avoid or minimize the danger of electrical shock due to partially exposed, electrically connected, prongs of a plug. My electrical outlet safety device and method of use has one or more of the features depicted in the embodiment discussed in the section entitled “DETAILED DESCRIPTION OF ONE ILLUSTRATIVE EMBODIMENT.” The claims that follow distinguish my device and method of use from the prior art; however, without limiting the scope of my device and method of use as expressed by these claims, in general terms, some, but not necessarily all, of their features are:

One, my safety device is configured to be attached to a conventional electrical plug. Such a conventional electrical plug has a connection side with a perimeter of a predetermined configuration and from which extend a pair of substantially identical parallel prongs that each have essentially the same length and essentially the same cross-sectional configuration and dimensions. The prongs are spaced apart a predetermined distance and fit within an electrical outlet that receives each individual prong so that substantially the entire length of each prong is within the outlet upon a safe connection of the plug and outlet.

Two, safety device comprises a resilient insulting member having a compressed state and an uncompressed state, for example, an open-celled polyurethane foam. The resilient insulting member includes a pair of parallel passageways spaced apart substantially the same distance as the distance between the individual prongs and positioned within a central section of the insulting member and oriented in a direction to extend between opposed sides of the insulting member. Optionally, the resilient insulting member is treated with a coating that impedes absorption of water.

Three, the resilient insulting member has a predetermined configuration so that, in the uncompressed state, each passageway has a length substantially equal to the length of an individual prong and has substantially the same cross-sectional dimensions as a prong. Upon being compressed in a direction that brings the opposed sides close to each other, each passageway has its length reduce to less than 0.10 inch when the insulting member is in the compressed state. The resilient insulting member in the uncompressed state has a depth that is substantially equal to the length of an individual prong and a perimeter that encompasses the pair of parallel passageways and is at least partially enclosed within the perimeter of the plug upon aligning the prongs the passageways and inserting the prongs essentially completely into the passageways. The cross-sectional configuration of the passageways may be substantially oblong. The passageways may each terminate in open ends in the opposed sides and my device includes a double-sided tape attached to one of the opposed sides. The tape has a pair of openings therein aligned with the open ends terminating in the one side, and the tape has one adhesive side bonded to one side of the block and another adhesive side of the tape covered with a removable cover sheet.

Four, in my safety device the perimeter of the resilient insulting member may at least be partially co-extensive with a substantial portion of the perimeter of the plug upon aligning the prongs the passageways and inserting the prongs essentially completely into the passageways. The resilient insulting member may have a substantially a cubical configuration comprising six substantially rectangular sides, and a height of substantially from 0.71 to 0.75 inch, a width substantially from 0.9 to 1.1 inch, and a depth substantially from 0.61 to 0.64 inch. In one embodiment, the resilient insulting member is adapted to be compressed in a direction that brings the opposed sides close to each other so they are separated by a distance of less than 0.10 inch, and is adapted to be compressed in a direction that parallels the direction of orientation of the passageways, decreasing the depth of insulting member by more than 80 percent.

One embodiment of my safety device includes a block of resilient insulating material that in the uncompressed state has a height of substantially from 0.71 to 0.75 inch, a width substantially from 0.9 to 1.1 inch, and a depth substantially from 0.61 to 0.64 inch. The block is adapted to be compressed in a direction to decrease its depth and to bring the opposed sides close to each other to decrease the depth by more than 80 percent. The pair of passageways are substantially linear and substantially parallel and extend in substantially the same direction as the direction of compression, each passageway having essentially an identical and uniform substantially oblong cross-sectional configuration along its entire length. These passageways are spaced apart essentially 0.69 inch. The block of resilient insulating material has a perimeter that encompasses the pair of parallel passageways and encloses a surface area of each opposed side sufficiently large so that one side of the block contacts and covers a substantial surface segment of a side of an electrical plug from which prongs project upon aligning the prongs with the passageways and inserting the prongs into the passageways. The block is adapted to be compressed in a direction that brings the opposed sides close to each other so they are separated by a distance of less than 0.10 inch, and it has sufficient resiliency to expand as a plug to which the device is mounted is partially removed from a outlet but lacks sufficient resiliency to push the plug from the outlet. The passageways each terminate in open ends in the opposed sides and the device includes a double-sided tape with one adhesive surface thereof bonded to one of the opposed sides and an opposed adhesive surface covered by a removable cover sheet, said tape and cover sheet each having a pair of openings therein aligned with the open ends terminating in the one side.

My method comprises the steps of

(a) prior to inserting the prongs into the outlet, mounting a resilient, compressible block of electrical insulating material to a connection side of the plug by inserting the prongs into passageways in the block that extend from one side of the block to another side of the block, and

(b) with the block mounted to the plug, pushing the prongs into the outlet so the prongs are essentially completely within the outlet and the block is essentially completely compressed to its minimum depth that does not exceed 0.10 inch, whereby the block expands to cover said exposed portions upon partial removal of the prongs from the electrical outlet that normally exposes said portions while in electrical connection.

These features are not listed in any rank order nor is this list intended to be exhaustive.

### DESCRIPTION OF THE DRAWING

One embodiment of my safety device and method are discussed in detail in connection with the accompanying drawing, which is for illustrative purposes only. This drawing includes the following figures (FIGS.), with like numerals indicating like parts:

FIG. 1 is a perspective view of one embodiment of my safety device.

FIG. 2A is a plan view of the adhesive tape side of my safety device.

FIG. 2B is a cross-sectional view taken along line 2B-2B of FIG. 2A showing a cover sheet for a double sided adhesive tape partially removed.

FIG. 3 is perspective view showing the cover sheet of the adhesive tape completely removed and my safety device correctly aligned with the prongs of the plug on which it is to be mounted.

FIG. 3A is perspective view of the embodiment of my safety device shown in FIG. 1 mounted on a plug and the plug's prongs partially inserted into an electrical outlet and a compressible block of my device in a completely uncompressed state.

FIG. 3B is perspective view similar to FIG. 3A showing the compressible block of my device in a completely compressed state and the prongs of the plug fully inserted into the outlet.

FIG. 4A is a side view, partially in cross-section, of my safety device in a partially compressed state mounted on a plug and the prongs of the plug partially inserted into a outlet sufficient to make electrical connection.

FIG. 4B is a side view similar to that of FIG. 4A showing of my safety device in a compressed state mounted on a plug and the prongs of the plug completely inserted into the outlet.

FIG. 5A is perspective view showing my safety device in an uncompressed state and mounted on the prongs of a very large plug.

FIG. 5B is perspective view showing my safety device in an uncompressed state and mounted on two prongs of a three pronged plug.

### DETAILED DESCRIPTION OF ONE ILLUSTRATIVE EMBODIMENT

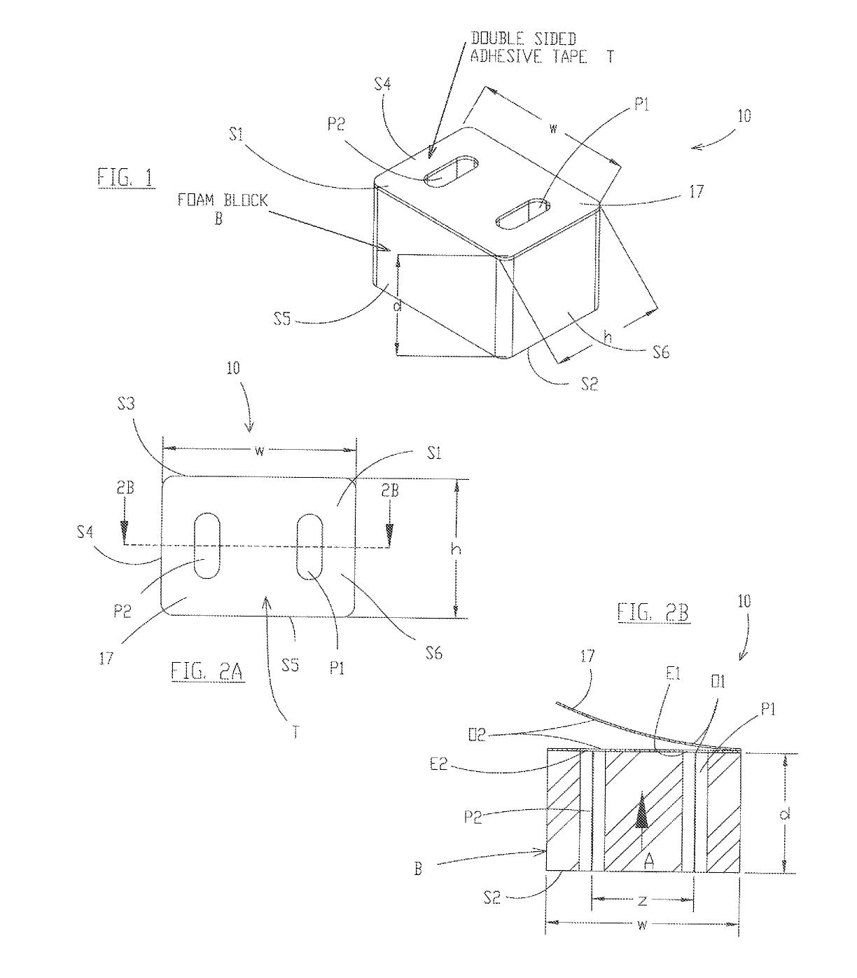

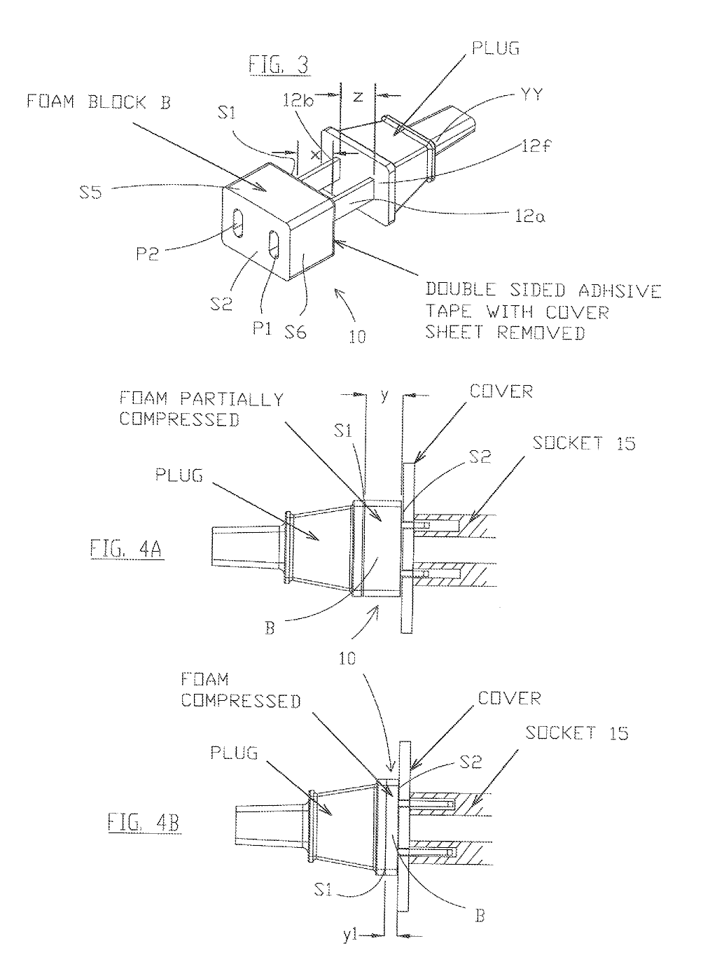

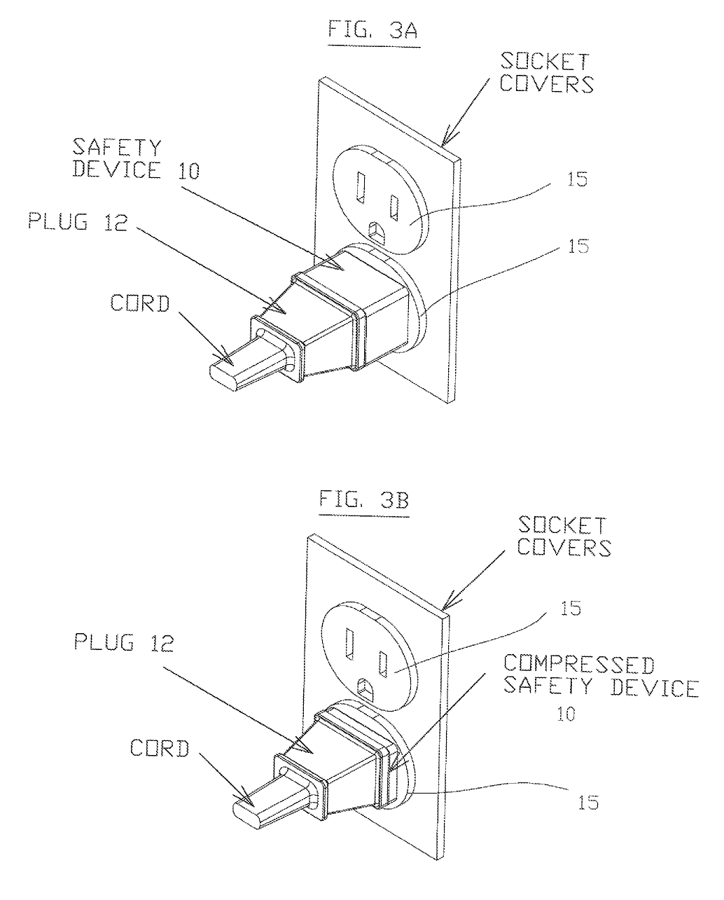

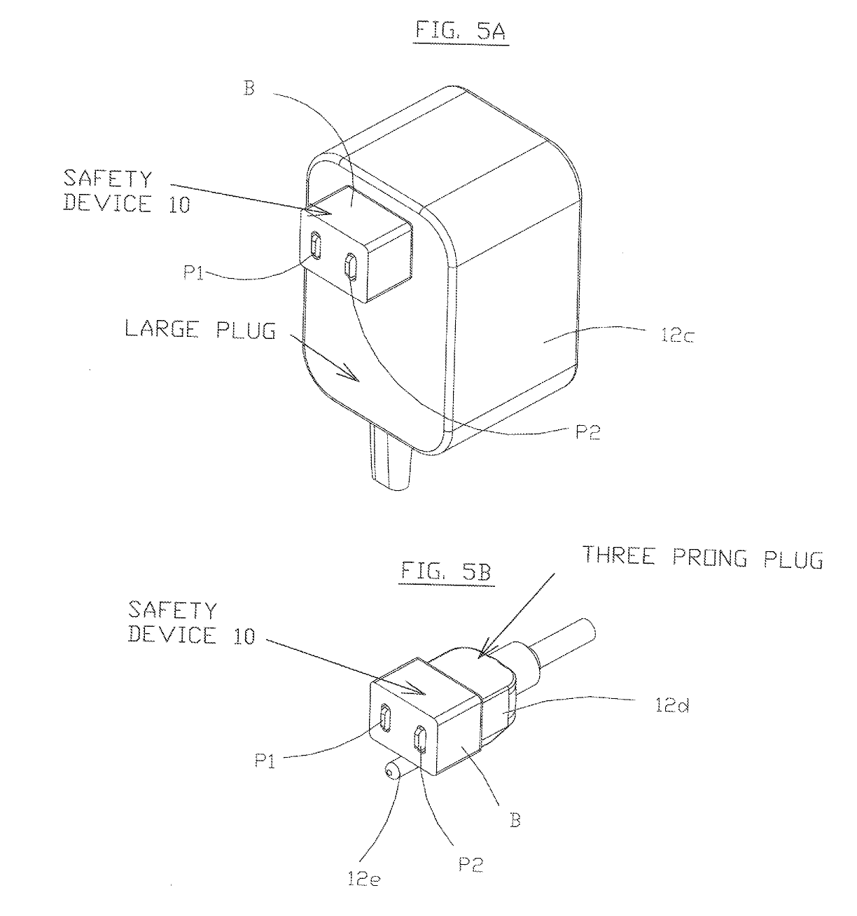

As shown in FIGS. 1 through 2B, my safety device 10 is used with an electrical plug 12 to protect against accidental electrical shock. My device 10 is mounted to the connection side 12f (FIG. 3) of the plug 12 with the plug's prongs 12a and 12b projecting through my device (FIGS. 4A and 4B). My device 10 comprises a resilient, compressible block B of electrical insulating material comprising, for example, an open-celled polyurethane foam. In some cases it may be desirable to spray or otherwise coat the surfaces of a cellular material with a polyurethane film that resists the absorption of water on the material. This material is essentially non-flammable and has essentially zero conductivity. The block B is soft enough to remain in a partially or fully compressed state when my device 10 is mounted on the plug 12 and connected to a socket or electrical outlet 15 as depicted in FIGS. 3B and 4B, but resilient enough to expand and cover partially exposed, electrically connected prongs (FIG. 4A). For example, the material may have a nominal density range substantially from 80 kilogram per cubic meter (kg/m³ (5.0 lb/ft³) to 95 kg/m³ (5.9 lb/ft³). In other words, the block B has sufficient resiliency to expand as the plug 12 to which my device 10 is mounted is partially removed from or inserted into an outlet but lacks sufficient resiliency to push the plug from the outlet.

My device 10 may also include a double-sided tape T attached to one of the block's sides, for example, side S1—the mounting side that faces the connection side 12f of the plug as depicted in FIG. 3. The surface of the side S1 and one adhesive surface of the tape T interface and are bonded together to hold the tape to the block B. The other adhesive side of the tape T is covered by a removable cover sheet 17, that is depicted as partially removed in FIG. 2B. This cover sheet 17 is removed just prior to attaching my device to the plug 12.

The block B is sized and configured to be mounted on the connection side 12f of the plug 12 by insertion of the prongs 12a and 12b into a pair of parallel, substantially linear passageways P1 and P2 that extend from the one side S1 of the block to the other side S2 of the block. The side S2 is the side of the block B that faces the electrical outlet into which the prongs 12a and 12b are to be inserted. The block B may have a substantially cubical configuration comprising six substantially rectangular, substantially flat sides S1 through S6 (FIGS. 1 through 2B), and a height h of substantially from 0.71 to 0.75 inch, a width w substantially from 0.9 to 1.1 inch, and a depth d substantially from 0.61 to 0.64 inch.

As best illustrated in FIG. 2B, the sides S1 and S2 are opposed and the passageways P1 and P2 are positioned within a central volumetric section of the block B and oriented in a direction indicated by the arrow A to extend linearly through the block between the opposed sides. The passageways P1 and P2 each terminate in open ends E1 and E2 (FIG. 2B) in the opposed sides S1 and S2. The tape T, including the cover sheet 17, has a pair of openings O1 and O2 therein aligned with the open ends of the passageways P1 and P2 terminating in the one side S1. Each passageway P1 and P2 has essentially an identical and uniform substantially oblong cross-sectional configuration along its entire length with a width of essentially 0.13 inch and a length of essentially 0.34 inch, about equal to the depth d dimension of the block B. The direction of each passageway P1 and P2 is oriented in the depth direction of the block B. As shown in FIG. 3, the passageways P1 and P2 are spaced apart a distance z that is essentially equal to the distance x between the prongs 12a and 12b (z=x), for example, essentially 0.69 inch. As shown in FIGS. 3B and 4B, the block B is adapted to be compressed in a direction indicated by the arrow A. In other words, the direction of compression of the block B parallels the direction of orientation of the passageways P1 and P2 and such compression brings the opposed sides S1 and S2 close to each other so they are separated by a distance y1 of less than 0.10 inch as illustrated in FIG. 4B. In the embodiment illustrated this decreases the depth d of the block B by more than 80 percent.

The size and configuration of my device 10 are critical to the effective interaction of my device with the plug 12 and are related to the dimensions of the plug. The double-sided tape T is an optional feature and has a minimal thickness that does not exceed approximately 0.005 inch, consequently having a negligible effect on the overall dimensions of my device 10. Moreover, when the tape T is used, the perimeter of the tape T and the block B are essentially co-extensive. My device is typically configured to be along or within the perimeter YY (FIG. 3) of the connection side 12f of the plug 12. As illustrated in FIGS. 3 through 4B, the electrical plug 12 has its connection side 12f with a perimeter of a predetermined configuration and dimensions, the perimeter of my device may be essentially identical and substantially co-extensive with all or a substantial portion of the perimeter of this plug. For example as depicted in as illustrated in FIGS. 3 through 4B, upon aligning the prongs 12a and 12b of the plug 12 with the passageways P1 and P2 and inserting the prongs 12a and 12b essentially completely into the passageways, the rectangular perimeter of the block B and the rectangular perimeter YY of the side 12f overlie and are essentially of identical dimensions. The perimeter of my device 10 encompasses the pair of parallel passageways P1 and P2 and encloses a surface area of each opposed side S1 and S2 sufficiently large so that, as the case may be, side S1 contacts and covers a substantial surface segment of the connection side 12f of the electrical plug 12 upon aligning the prongs 12a and 12b with the passageways and essentially completely inserting the prongs into the passageways as depicted in FIGS. 3B and 4B. In the uncompressed state the block B has a depth d that is substantially equal to the length of an individual prong; however, the depth d may be such that a tip portion of each individual prong may project slightly from the side S2 in the uncompressed state.

As shown best in FIG. 3, extending from the connection side 12f of the plug 12 are a pair of substantially identical parallel prongs 12a and 12b that each have essentially the same length and essentially the same cross-sectional configuration and dimensions. The prongs 12a and 12b are typically spaced apart a distance x substantially from 0.45 to 0.55 inch. As illustrated in FIGS. 4A and 4B, these prongs 12a and 12b fit within the electrical outlet 15 that receives each individual prong. Substantially the entire length of each prong is within the outlet upon a safe connection of the plug 12 and outlet as shown in FIGS. 3B and 4B. The pair of parallel passageways P1 and P2 are spaced apart substantially the same distance z as the distance x between the individual prongs 12a and 12b. In the uncompressed state of the block B, each passageway P1 and P2 may have a length that is equal to or a little less or a little greater than the length of an individual prong. Moreover, each passageway P1 and P2 may have substantially the same cross-sectional configuration and dimensions as a prong. Upon the block B being compressed in a direction indicated by the arrow A, each passageway P1 and P2 has its length reduce to less than 00.10 inch. Thus the block B has: (i) a fully compressed state with the prongs 12a and 12b extending through the block and completely into an electrical outlet (FIGS. 3B and 4B), (ii) a partially compressed state with the prongs 12a and 12b only partly inserted into an electrical outlet so that portions thereof are exposed and the block B partially expanded to cover said exposed portions (FIG. 4A), and (iii) a completely uncompressed state (FIGS. 3 and 3A). In a fully compressed state with the prongs 12a and 12b extending through the block B as illustrated in FIGS. 3B and 4B more than 80 percent of the length of the prongs projects from the outlet side S2 and essentially completely extends into an electrical outlet upon connection thereto.

My device 10 reduces the danger associated with a plug that is partially withdrawn from an electrical outlet to exposed its prongs 12a and 12b while still in electrical connection. According to my method, prior to inserting the prongs 12a and 12b into the outlet, my device 10 is mounted to the connection side 12f of the plug 12 after removable of the cover sheet 17 so the exposed adhesive affixes my device to the plug 12. By inserting the prongs 12a and 12b into passageways P1 and P2, and with the block B mounted to the plug 12, a user pushes the prongs into the electrical outlet 15 so the prongs 12a and 12b are essentially completely within the outlet and the block B is essentially completely compressed to its minimum depth that does not exceed 0.10 inch. The block B will expand to cover exposed portions upon partial removal of the prongs 12a and 12b from the electrical outlet 15 that normally exposes these portions while in electrical connection. The block B of electrical insulting material surrounds the partially exposed prongs 12a and 12b, encasing these exposed prong portions within the block B to prevent a person, particularly children, from directly, or indirectly with an object, contacting the exposed prong portions.

FIG. 5A shows my device 10 mounted on an enlarged plug 12c having a perimeter that is much greater than the perimeter of the side S1 of the block B. FIG. 5B shows my device 10 mounted on a three prong plug 12d having a ground prong 12e. The dimensions of my device 10 in the embodiments depicted allow the ground prong 12e to bypass the block B when my device in mounted on the plug 12d.

### SCOPE OF THE INVENTION

The above presents a description of the best mode I contemplated of carrying out my safety device and method of use and of the manner and process of making and using, in such full, clear, concise, and exact terms as to enable any person skilled in the art to make and use my device and method. My device and method are, however, susceptible to modifications and alternate constructions from the illustrative embodiment discussed above which are fully equivalent. Consequently, it is not the intention to limit my device and method to the particular embodiment disclosed. On the contrary, my intention is to cover all modifications and alternate constructions coming within the spirit and scope of my device and method as generally expressed by the following claims, which particularly point out and distinctly claim the subject matter of my invention:

1. A safety device for an electrical plug having a connection side with a perimeter of a predetermined configuration and from which extend a pair of substantially identical parallel prongs that each have essentially the same length and essentially the same cross-sectional configuration and dimensions, said prongs being spaced apart a predetermined distance and fitting within an electrical outlet that receives each individual prong so that substantially the entire length of each prong is within the outlet upon a safe connection of the plug and outlet,
said safety device comprising
a resilient insulting member having a compressed state and an uncompressed state and including a pair of parallel passageways spaced apart substantially the same distance as the distance between said individual prongs and positioned within a central section of the insulting member and oriented in a direction to extend between opposed sides of the insulting member,
said resilient insulting member having a predetermined configuration so that, in the uncompressed state, each said passageway
has a length substantially equal to the length of an individual prong and
has substantially the same cross-sectional dimensions as a prong and,
said resilient insulting member upon being compressed in a direction that brings said opposed sides close to each other, each said passageway has its length reduce to less than 0.10 inch when the insulting member is in the compressed state,
said resilient insulting member in the uncompressed state having a depth that is substantially equal to the length of an individual prong and a perimeter that encompasses the pair of parallel passageways and is at least partially enclosed within said perimeter of the plug upon aligning the prongs the passageways and inserting the prongs essentially completely into the passageways.

2. The safety device of claim 1 where the perimeter of the resilient insulting member is at least partially co-extensive with a substantial portion of said perimeter of the plug upon aligning the prongs the passageways and inserting the prongs essentially completely into the passageways.

3. The safety device of claim 1 where the resilient insulting member has
a substantially a cubical configuration comprising six substantially rectangular sides, and
a height of substantially from 0.71 to 0.75 inch, a width substantially from 0.9 to 1.1 inch, and a depth substantially from 0.61 to 0.64 inch.

4. The safety device of claim 1 where the resilient insulting member is adapted to be compressed in a direction that brings the opposed sides close to each other so they are separated by a distance of less than 0.10 inch.

5. The safety device of claim 1 where the resilient insulting member is adapted to be compressed in a direction that parallels the direction of orientation of the passageways, decreasing the depth of insulting member by more than 80 percent.

6. The safety device of claim 1 where the cross-sectional configuration of the passageways is substantially oblong.

7. The safety device of claim 1 where the resilient insulting member comprises an open-celled polyurethane foam.

8. The safety device of claim 1 where the passageways each terminate in open ends in the opposed sides and said device includes a double-sided tape attached to one of the opposed sides, said tape having a pair of openings therein aligned with the open ends terminating in said one side, said tape having one adhesive side bonded to one side of the block and another adhesive side of the tape covered with a removable cover sheet.

9. The safety device of claim 1 where the resilient insulting member is treated with a coating that impedes absorption of water.

10. A safety device for an electrical plug comprising
a block of resilient insulating material having a compressed state and an uncompressed state and a pair of opposed sides, said block in the uncompressed state having a height of substantially from 0.71 to 0.75 inch, a width substantially from 0.9 to 1.1 inch, and a depth substantially from 0.61 to 0.64 inch,
said block adapted to be compressed in a direction to decrease its depth and to bring the opposed sides close to each other to decrease said depth by more than 80 percent, and
a pair of substantially linear and substantially parallel passageways extending in substantially the same direction as the direction of compression, each passageway having essentially an identical and uniform substantially oblong cross-sectional configuration along its entire length,
said passageways being spaced apart essentially 0.69 inch.

11. The safety device of claim 10 where the block of resilient insulating material has a perimeter that encompasses the pair of parallel passageways and encloses a surface area of each opposed side sufficiently large so that one side of the block contacts and covers a substantial surface segment of a side of an electrical plug from which prongs project upon aligning the prongs with the passageways and inserting the prongs into the passageways.

12. The safety device of claim 10 where the block of resilient insulting material is adapted to be compressed in a direction that brings the opposed sides close to each other so they are separated by a distance of less than 0.10 inch.

13. The safety device of claim 10 where the block of resilient insulting material has sufficient resiliency to expand as a plug to which said device is mounted is partially removed from a outlet but lacks sufficient resiliency to push the plug from the outlet.

14. The safety device of claim 10 the passageways each terminate in open ends in the opposed sides and said device includes a double-sided tape with one adhesive surface thereof bonded to one of the opposed sides and an opposed adhesive surface covered by a removable cover sheet, said tape and cover sheet each having a pair of openings therein aligned with the open ends terminating in said one side.

15. The safety device of claim 10 where the block of resilient insulting material is treated with a coating that impedes absorption of water.

16. A safety device for an electrical plug with prongs projecting from a connection side of the plug, said device comprising
a resilient, compressible block of electrical insulating material including passageways that extend through the block from a mounting side of the block to an opposed outlet side of the block that, with the device attached to the plug, faces an outlet into which the prongs are to be inserted,
said block sized and configured to be mounted on the connection side of the plug by insertion of the prongs into the passageways,
said block having
(i) a fully compressed state with the prongs extending through the block so that more than 80 percent of the length of the prongs projects from the outlet side and essentially completely extends into an electrical outlet upon connection thereto,
(ii) a partially compressed state with the prongs only partly inserted into a outlet so that portions thereof are exposed and the block partially expanded to cover said exposed portions, and
(iii) a completely uncompressed state,
said sides of the block having substantially flat surfaces that are parallel and the passageways terminate in open ends in said surfaces, and
said mounting side bearing a double-sided tape with one adhesive surface thereof bonded to the flat surface of the mounting side and another adhesive surface thereof covered by a removable cover sheet,
said tape and cover sheet each having a pair of openings therein aligned with the open ends terminating in said mounting side.

17. A method of reducing the danger associated with a plug that is partially withdrawn from an electrical outlet to exposed prongs of the plug while in electrical connection, said method comprising the steps of
(a) prior to inserting the prongs into the outlet, mounting a resilient, compressible block of electrical insulating material to a connection side of the plug by inserting the prongs into passageways in the block that extend from one side of the block to another side of the block, and
(b) with the block mounted to the plug, pushing the prongs into the outlet so the prongs are essentially completely within the outlet and the block is essentially completely compressed to its minimum depth that does not exceed 0.10 inch, whereby the block expands to cover said exposed portions upon partial removal of the prongs from the electrical outlet that normally exposes said portions while in electrical connection.
